(19) United States
(12) Patent Application Publication
(10) Pub. No.: US 2025/0014257 A1
(43) Pub. Date: Jan. 9, 2025

(54) PIXEL WAVE ATTRIBUTE INITIALIZATION

(71) Applicant: ATI TECHNOLOGIES ULC, Markham (CA)

(72) Inventor: Wilfred W. Kwok, Markham (CA)

(21) Appl. No.: 18/478,774

(22) Filed: Sep. 29, 2023

Related U.S. Application Data
(60) Provisional application No. 63/524,748, filed on Jul. 3, 2023.

(51) Int. Cl. G06T 15/00; G06T 1/20; G06T 1/60

(52) U.S. Cl. CPC G06T 15/005; G06T 1/20; G06T 1/60; G06T 2210/52

(57) ABSTRACT

Techniques are described for avoiding reinitialization of attributes for successive redundant pixel waves when rendering graphical primitives. Attributes of a first primitive are read from a parameter cache to initialize a first pixel wave. Attributes are stored in blocks of a local data store associated with a compute unit rendering the pixel wave. A tracking array is maintained to indicate the local data store blocks storing the attributes. When a second pixel wave associated with the first primitive is detected, reading of the attributes is omitted based on the tracking array.

### BACKGROUND

In computer graphics processing, a primitive is a basic geometric entity that forms the smallest building block of a graphical image. Examples of primitives include points, lines, and triangles. During the rendering process for the graphical image, a primitive is associated with one or more pixels, which are the smallest controllable elements of a picture represented on a screen. The color, position, and other properties of these pixels determine the appearance of the primitive. Graphics Processing Units (GPUs) process these primitives during the rendering process to generate the final graphical output seen on a display.

A pixel wave represents a group of pixels that are processed together in parallel on a GPU, which processes many pixels at once to optimize speed and efficiency. To facilitate such processing, the pixels to be processed may be grouped together into ‘waves’. Each pixel within a pixel wave undergoes the same operations, such as via execution of a pixel shader program (a type of computer program often used in 3D computer graphics to determine the final color of a pixel in a rendered image). This approach to parallel processing takes advantage of the fact that operations on pixels often involve similar computations, enabling GPUs to process graphics data much more quickly and efficiently than would be possible using serial processing.

However, the management of these pixel waves presents challenges with respect to resource utilization and power efficiency, particularly when dealing with large primitives that cover significant portions of the display frame. Storage and initialization of pixel attributes for each wave can lead to redundancies and unnecessary power consumption, highlighting a need for improved techniques in the management of pixel waves.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 illustrates two large triangular primitives, which together occupy the entirety of a display frame.

FIG. 2 is a block diagram of a processing system suitable for implementing selective initialization of redundant pixel waves in accordance with some embodiments.

FIG. 3 illustrates successive stages of a Pixel Wave Attribute Tracking Array (PWATA) during the processing of successive pixel waves of a large primitive, in accordance with one or more embodiments.

FIG. 4 illustrates an operational flow routine partially depicting operations for processing instructions to render one or more primitives using one or more compute units, in accordance with one or more embodiments.

### DETAILED DESCRIPTION

Large primitives are used in various graphics rendering scenarios, including gaming (in which even complex environments may include large areas of substantially identical pixel attributes, such as the sky, walls, bodies of water, etc.); video rendering and/or streaming; computer-aided design and modeling; image/video editing; etc. In each of these scenarios, large areas of the display may be associated with identical pixel attributes, each of which may describe a parameter such as color, texture, depth, etc.

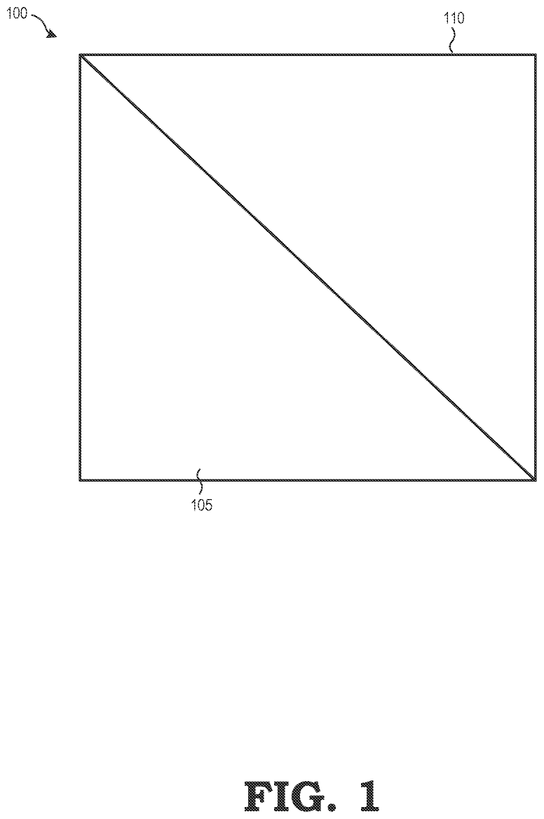

FIG. 1 illustrates two large triangular primitives 105 and 110, which together occupy the entirety of a display frame 100. In many real-world applications (e.g., mobile benchmarks, gaming, video streaming, and other applications), pixel shader operations often involve large primitives that span a large portion of the display frame. Moreover, in various drawing operations, a graphics processing unit (GPU) launches multiple pixel waves for execution at one or more of its compute units (CUs) to draw a single primitive. For example, in some scenarios, multiple pixel shaders may be executed on every pixel of the display frame 100 in order to render the two large primitives 105, 110 that collectively cover the whole screen.

In conventional approaches, rendering each large primitive 105, 110 involves initiating a read operation to access attributes associated with each pixel wave associated with each large primitive 105, 110. The attributes are then written to a local data store (LDS) within each CU, such that each pixel wave has the attribute data stored and available for processing at each CU. However, successive pixel waves may share common attributes and even be assigned the same LDS address, such that subsequent pixel waves could use this data without the need for new cache-to-LDS cycles to rewrite the same attributes for those subsequent pixel waves. Thus, in conventional approaches the rendering of large primitives typically involves redundant initialization of pixel attributes for each pixel wave regardless of whether those pixel waves are substantially identical, resulting in wasted resources and increased power consumption. In particular, the switching power utilized in the LDS contributes to higher power consumption, increased heat generation, and potentially shorter battery life (such as in mobile devices).

Embodiments of techniques described herein leverage common local data storage utilized by successive pixel waves associated with the same large primitives to avoid reinitialization of attributes for those successive pixel waves. For each pixel wave, scheduling circuitry (sometimes referred to as a shader processor input, or SPI) initiates a reading of attributes of the corresponding primitive from parameter cache (PC) circuitry, and the PC circuitry writes the attributes to addresses allocated for the pixel wave by the scheduling circuitry to a respective local data store (LDS) for each of one or more compute units assigned to render the corresponding primitive. When a pixel wave retires, another pixel wave of the same large primitive may be assigned the same LDS address. If the prior pixel wave does not overwrite the LDS locations for the attributes, the attributes might be used by the subsequent pixel wave without consuming new processing (PC_LDS) cycles writing attributes again. In such a situation, the attribute initialization for one or more of the subsequent pixel waves can be considered redundant, and omitted by the scheduling circuitry accordingly. In certain embodiments, the described techniques involve maintaining a pixel wave attribute tracking array (PWATA, also termed scoreboard) to monitor and identify the local data store (LDS) locations where attributes for large primitives are stored, enabling the system to quickly determine whether attribute reinitialization for a successive pixel wave is necessary or can be deemed redundant.

Embodiments of these techniques could help optimize the rendering of such large primitives, improving performance and reducing power consumption, such as in mobile gaming or other scenarios in which power efficiency is crucial.

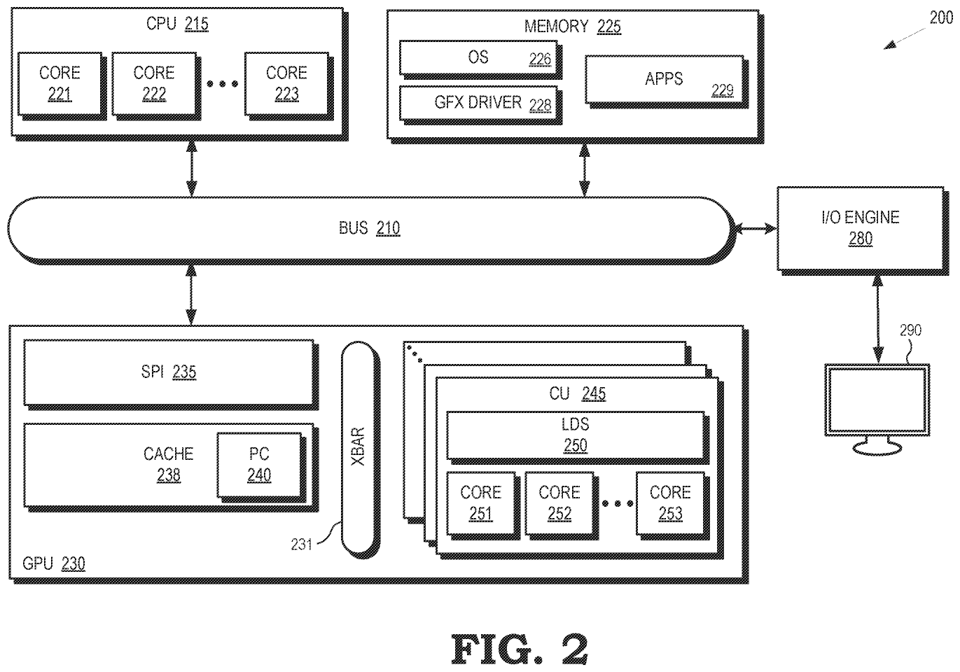

FIG. 2 is a block diagram of a processing system 200 implementing selective initialization of redundant pixel waves in accordance with some embodiments. The processing system 200 comprises a central bus 210 facilitating communication between the various components of the system, such as by enabling efficient data exchange and synchronization between different processing units (e.g., CPU 215 and GPU 230), memory components (e.g., memory 225), and input/output mechanisms (e.g., I/O engine 280). Various embodiments of the processing system 200 include other buses, bridges, switches, routers, and the like, which are not separately shown in FIG. 2 in the interest of clarity.

The bus 210 is communicatively coupled to a central processing unit (CPU) 215, which orchestrates the overall operations of the processing system 200. The CPU 215 includes multiple processor cores 221-223, allowing it to execute several tasks concurrently (in parallel). These processor cores 221-223 are responsible for executing the primary software instructions, including system-level operations, application processes, and certain graphics-related functions. In some embodiments, one or more of the processor cores 221-223 each operate to perform the same operation(s) on different data sets (e.g., via Single Instruction Multiple Data or SIMD processing). Though in the example embodiment illustrated in FIG. 2, three processor cores 221-223 are depicted to represent an arbitrary M number of cores, the number of processor cores 221-223 implemented in the CPU 215 is a matter of design choice. As such, in other embodiments, the CPU 215 can include any number of processor cores 221-223. The processor cores 221-223 execute instructions such as program code 225 stored in the memory 225 and the CPU 215 stores information in the memory 225 such as the results of the executed instructions. The CPU 215 is also able to initiate graphics processing by issuing draw calls to the GPU 230.

An input/output (I/O) engine 280 communicatively couples the processing system 200 to external devices and peripherals such as keyboards, mice, printers, external disks, and the like. One such device connected to the I/O engine 280 is the display 290, which visually presents the graphics and other visual content processed by the processing system 200, including one or more large primitives optimized via selective initialization of redundant pixel waves.

A memory 225 is also communicatively coupled to the bus 210 and serves as the main data storage for the processing system 200 using a non-transitory computer-readable medium such as a dynamic random-access memory (DRAM). However, in various embodiments, the memory 225 is implemented using other types of memory including, for example, static random-access memory (SRAM), nonvolatile RAM, and the like. In the depicted embodiment, the memory 225 stores some or all of an operating system (OS) 226, which oversees and manages hardware resources; a graphics driver 228, which provides a bridge between software applications and the GPU 230, translating application requests into hardware-level operations; and applications 229, which include various software programs that might be run by the user, some of which may generate graphical data or tasks that utilize one or more facilities of the GPU 230.

Techniques described herein are, in various embodiments, employed at least in part by the GPU 230. The GPU 230 includes, for example, any of a variety of parallel processors, vector processors, coprocessors, accelerated processing units (APUs), general-purpose GPUs (GPGPUs), non-scalar processors, highly parallel processors, artificial intelligence (AI) processors, inference engines, machine learning processors, other multithreaded processing units, scalar processors, serial processors, or any combination thereof. The GPU 230 handles specialized graphics and computation tasks, offloading such functions from the CPU 215. For example, the GPU 230 renders objects (e.g., groups of primitives) according to one or more shader programs to produce values of pixels that are provided to the display 290, which uses the pixel values to display an image that represents the rendered objects.

To render the objects, the GPU 230 implements a plurality of compute units 245 that execute instructions concurrently or in parallel from, for example, one or more applications 229. For example, the GPU 230 executes via the compute units 245 instructions from a shader program, raytracing program, graphics pipeline, or the like using a plurality of GPU cores 251-253 to render one or more objects.

The GPU 230 comprises a plurality of compute units 245 for processing graphics tasks and computation tasks of the GPU 230 in parallel. In some embodiments, the CPU 215 and the GPU 230 have an equal number of processing cores, while in other embodiments, the CPU 215 and the GPU 230 have a different number of processing cores. In the depicted embodiment of FIG. 2, three GPU cores 251-253 are presented representing an arbitrary N number of GPU cores, with those GPU cores 251-253 being organized by and associated with each of an arbitrary number of compute units (CUs) 245. Each CU 245 includes its own local data store (LDS) 250, which enables the shader cores 251-253 to rapidly read and write data during processing. The LDS 250, for example, is configured to store values, register files, operands, instructions, variables, result data (e.g., data resulting from the performance of one or more operations), flags, or any combination thereof necessary for, aiding in, or helpful for performing one or more operations indicated in one or more instructions from an application 229. With respect to various techniques described herein, the LDS 250 stores attributes of large primitives, optimizing how these attributes are initialized to avoid redundancies, such as for pixel waves utilized to render those large primitives.

Each CU 245 contains multiple GPU cores 251-253, which handle various tasks such as vertex shading, pixel shading, and other graphics-related computations. In particular, the GPU cores 251-253 process the pixel waves and benefit from selective initialization of those pixel waves to improve efficiency. In various embodiments, the number of compute units 245 and their respectively associated GPU cores 251-253 may be selected as a matter of design choice. Thus, in other implementations, the GPU 230 can include any number of compute units 245 and/or processor cores 251-253. Some implementations of the GPU 230 are used for general-purpose computing. The GPU 230 executes instructions such as program code (e.g., shader code, raytracing code) included in one or more of the applications 229 (e.g., shader programs, raytracing programs) stored in the memory 225, and the GPU 230 stores information in the memory 225 such as the results of the executed instruction. In the depicted embodiment, the memory 225 further includes some or all of an operating system (OS) 226, such as to provide an interface between the applications 229 and the graphics driver 228.

In the depicted embodiment, operations of the GPU 230 are managed by the Shader Processor Input (SPI) 235. The SPI 235 comprises scheduling circuitry that determines how tasks are allocated among the compute units (CUs) 245 and ensures that data attributes, such as pixel wave attributes, are available when needed. For example, the SPI 235 is responsible for managing and scheduling the execution of a list of commands sent to the GPU 230 for processing. These commands are typically a sequence of low-level instructions that specify various operations, ranging from drawing primitives and setting colors to updating textures. Each graphical primitive is at least partially defined by its vertices, each of which identifies a point in 3D space and may also include additional associated data like color, texture coordinates, normals, and other attributes critical for rendering. Each vertex's associated data or attributes are stored at specific locations or addresses in the Parameter Cache (PC) 240. In certain embodiments, a unique identifier for any given primitive (e.g., a triangle) is based on the particular locations in the PC 240 at which its vertices' data are stored.

The SPI 235 ensures that the received graphical instructions are executed in the correct order and that any needed data from PC 240 are available for decoding the commands and translating those commands into the appropriate hardware instructions for execution by one or more CUs of the plurality of compute units 245. In the depicted embodiment, SPI 235 additionally coordinates the selective initialization of redundant pixel waves to optimize the pixel wave attribute initialization process.

As part of GPU 230, a multilevel cache hierarchy is implemented and represented in a simplified manner by cache 238. Within the cache 238, the PC 240 stores the attributes associated with different graphical primitives and used during the rendering process, including vertex data for each primitive. The GPU 230 further includes a crossbar (XBAR) 231, which operates as an intermediary switch connecting and managing data traffic between the multiple compute units (CUs) 245, the SPI 235, and the cache 238.

In various scenarios and architectures, a single pixel wave may include pixels from multiple primitives, the likelihood of which is higher for pixel waves that are launched in order to render smaller primitives. In contrast, for pixel waves launched to render large primitives, all pixels are likely associated with a single such large primitive—for which a single LDS block typically contains all attribute data of that one large primitive. Thus, in various embodiments, the SPI (Shader Processor Input) 235 utilizes one or more predefined criteria to identify large primitives being processed by the SPI 235, and thereby to identify potentially redundant pixel waves for purposes of avoiding reinitialization of the attributes associated with one or more of those redundant pixel waves. For example, in certain embodiments one or more of the following criteria are utilized: identifying primitives for which all pixels of a given pixel wave exclusively belong; identifying pixel waves associated with attributes that are confined to a singular LDS block; identifying pixel waves associated with attributes that are confined to a singular LDS block of a predetermined size (e.g., 512 bytes or other predetermined size); identifying primitives based on PC (Parameter Cache) 240 addresses corresponding to one or more defined vertices of the primitive; identifying primitives based on one or more subsequent pixel waves exhibiting a substantially identical set of addresses within the PC 240, indicative of their association with a previously identified large primitive; etc. In various embodiments, upon receiving a primitive that satisfies one or more of these or other predefined criteria, the SPI 235 recognizes the presence of a large primitive. In certain embodiments, upon processing a pixel wave belonging to a different primitive, (such as may be determined by a variation in parameter cache addresses), the SPI 235 may invalidate (e.g., erase PWATA entries for) a previously detected large primitive.

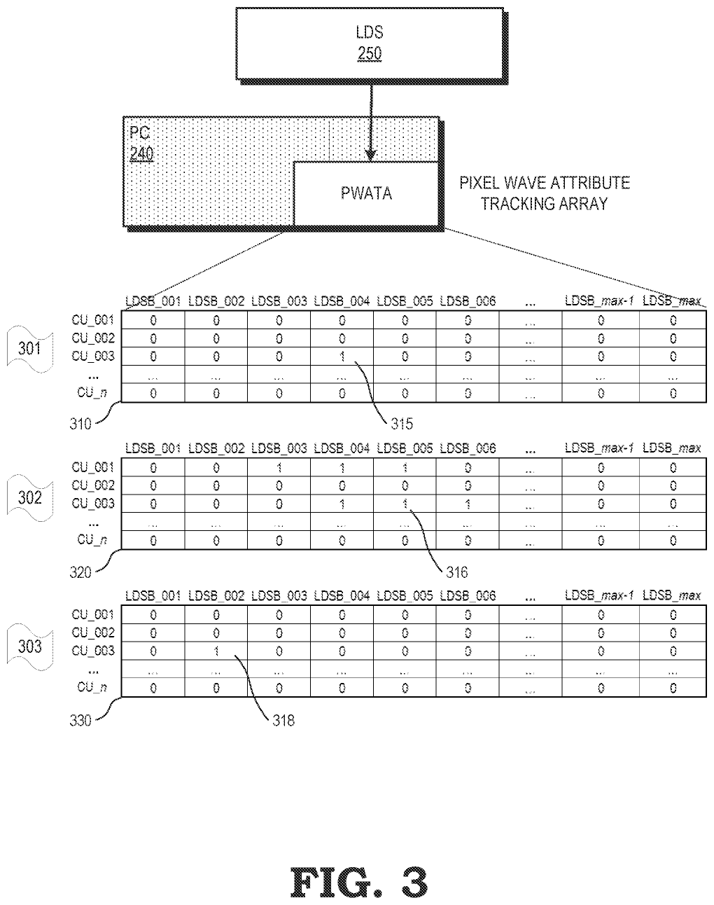

FIG. 3 illustrates successive stages of a Pixel Wave Attribute Tracking Array during the processing of successive pixel waves in accordance with one or more embodiments. The PWATA facilitates efficient pixel wave attribute initialization for identified large primitives, such as to reduce the number of processing cycles by avoiding redundant initializations of those attributes. In some embodiments, the PWATA is stored in the parameter cache (PC) 240 of the GPU 220, enabling rapid access to parameters stored for use in processing successive pixel waves 301, 302, and 303.

As discussed elsewhere herein, contents of the PC 240 are typically provided as part of graphical instructions (e.g., drawing commands or rendering instructions) sent to the GPU, and generally stored by the PC 240 as part of parsing those graphical instructions and their associated graphical primitives and other associated data. Thus, as noted above, the PC 240 stores parameters of graphical primitives that are processed by the CUs 245 for rendering or other GPU-related tasks. In the context of graphical processing, these attributes typically include information such as vertex positions, colors, texture coordinates, normals, and other data that describe the primitives to be rendered. The PWATA serves to track which LDS blocks have already been initialized with the attributes of a particular large primitive. In certain embodiments and scenarios, the SPI 235 may process other additional shader types (e.g., compute shaders, geometry shaders, etc.) along with the processing of pixel shaders, such as via interleaving or some other arrangement. In such scenarios, when the SPI 235 launches a non-pixel shader wave, it clears certain PWATA entries for corresponding LDS blocks that are assigned to waves unrelated to the identified large primitive.

Interactions between SPI 235 (not separately shown in FIG. 3), the LDS 250, and PC 240 during the processing of pixel waves 301, 302, 303 result in different bit patterns reflected in successive arrangements of the PWATA as it tracks attribute data stored within the LDS 250 for those successive pixel waves 301, 302, 303. Thus, FIG. 3 depicts three successive states associated with each of those successive pixel waves in particular, the processing of a first pixel wave 301 results in a PWATA state 310; the processing of a second later pixel wave 302 (after some arbitrary quantity of zero or more additional pixel waves) results in PWATA state 320, and the processing of a third pixel wave 303 (which again may occur after some arbitrary quantity of zero or more additional pixel waves since earlier pixel wave 302) results in a PWATA state 330. In each respective PWATA state 310, 320, 330, rows correspond to individual Compute Units (CU 001 through CU_n, with ‘n’ representing a total quantity of compute units 245) and columns correspond to LDS blocks (LDSB_001 through LDSB_max, such that ‘max’ indicates a total quantity of storage blocks in the LDS corresponding to each CU of those CUs 245. Notably, while each block of the LDS 250 stores a predefined quantity of data (e.g., 512 B or other quantity), each corresponding location of the PWATA stores a single bit to track the contents of the respective LDS associated with a particular compute unit. Specifically, as each successive pixel wave 301, 302, 303 is processed, the bits of the respective PWATA state 310, 320, 330 track where attribute data for those successive pixel waves is stored within each CU's corresponding LDS.

Upon processing the first pixel wave 301, the PWATA state 310 registers a specific bit in a position 315 that is associated with LDSB_004 of the CU_003 row. This bit signifies the initialization of a specific LDS block, corresponding to the position 315 in the PWATA, that stores the attributes of a large primitive associated with pixel wave 301. The attributes, which can be vertex data, colors, texture mappings, among others, are loaded by SPI 235 from PC 240 and written to a specific LDS block for access by the compute unit (CU_003) assigned to process the pixel wave 301. In addition, the SPI 235 updates the PWATA state 310 to set the specific bit in position 315 associated with that particular LDS block for the assigned compute unit CU_003, thereby tracking the initialization of attributes associated with pixel wave 301.

When the second pixel wave 302 is processed sometime later, SPI 235 again coordinates the retrieval of attribute data. As discussed herein, pixel wave 302 may be any of one or more successive pixel waves occurring subsequent to pixel wave 301 that are associated with the large primitive associated with that pixel wave 301. Based on the parameter cache addresses associated with pixel wave 302, the SPI 235 determines that the pixel wave 302 is associated with that same large primitive, and that the attribute data for the pixel wave 302 is stored in an LDS block corresponding to position 316. By checking the position 316 of PWATA state 320, which retains the ‘1’ value from the processing of one of the successive pixel waves occurring subsequent to pixel wave 301, the SPI 235 determines that the attributes for the pixel wave 302 are already stored in the LDS block corresponding to PWATA state 320 at position 316. Accordingly, by identifying the positive bit in position 316 of PWATA state 320, the SPI 235 avoids re-initializing these LDS blocks with the same pixel wave attribute data as was previously stored during the processing of a previous pixel wave associated with the same identified large primitive.

Upon receiving a later third pixel wave 303 for processing, SPI 235 determines, based on the parameter cache addresses associated with that pixel wave 303, that it is associated with a different primitive than that which was associated with the pixel waves 301 and 302. Accordingly, the SPI 235 clears the PWATA, resetting all bits to ‘0’ and then setting the bit (in this example, at position 318 of PWATA state 330) corresponding to an LDS block in which the attributes of pixel wave 303 are stored. As with pixel waves 301 and 302, attributes of the pixel wave 303 are loaded by SPI 235 from PC 240 and written to an LDS block for access by the compute unit (CU_003) assigned to process the pixel wave 303.

Thus, through the evolving PWATA states 310, 320, 330 as depicted in FIG. 3, the GPU 230 (and in particular, SPI 235) utilizes the PWATA to avoid redundant attribute initialization processes associated with successive pixel waves for the same large primitive.

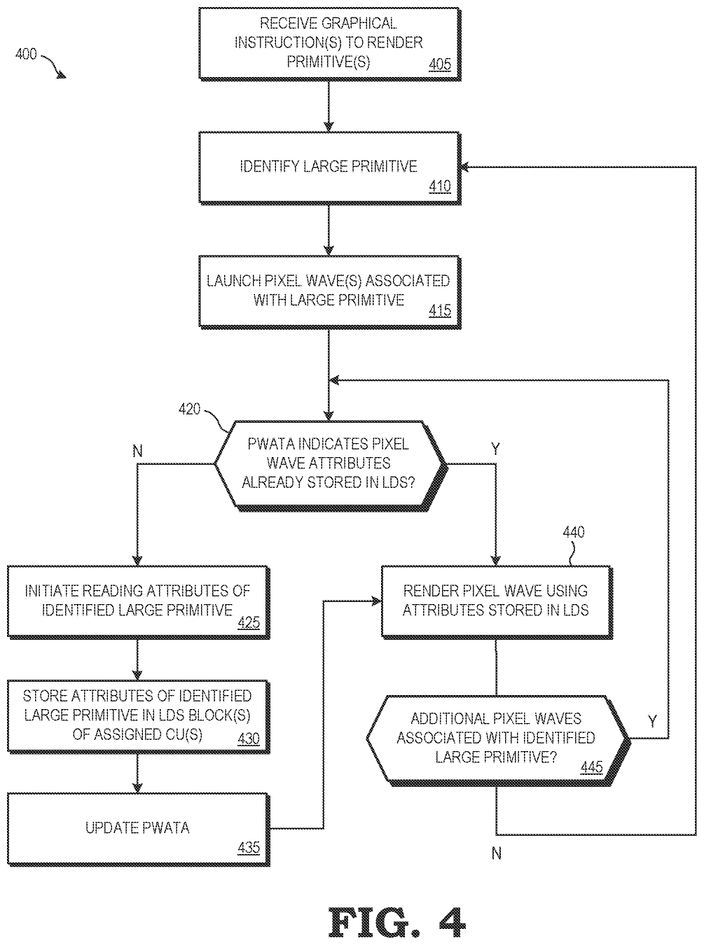

FIG. 4 illustrates an operational flow routine 400 partially depicting operations of, for example, SPI 235 (with reference to FIG. 2) when processing instructions to render one or more primitives using one or more compute units (e.g., one or more of compute units 245 in FIG. 2), in accordance with one or more embodiments. The flow routine 400 facilitates the pixel wave attribute initialization process, aiming to reduce redundancy and thereby improve overall rendering efficiency.

The routine 400 begins at block 405, in which the SPI receives graphical instructions to render one or more primitives, such as via a draw call to the incorporating GPU (e.g., GPU 230 of FIG. 2). Such graphical instructions are typically encapsulated within drawing commands or rendering instructions, and convey details for each specified primitive such as vertex positions, colors, and texture coordinates. The routine proceeds to block 410.

At block 410, the SPI identifies a large primitive within those specified by the graphical instructions received in block 405. As discussed elsewhere herein, in various embodiments such large primitives are identified based on various criteria, such as (as non-limiting examples): a quantity of pixels encompassed by the primitive; the associated pixel wave attributes occupying specific memory space constraints (e.g., being stored within a single LDS block); a consistency of parameter cache addresses associated with one or more vertices of the primitive; etc. The routine proceeds to block 415.

At block 415, the SPI launches one or more pixel waves associated with the large primitive identified in block 410. These pixel waves correspond to the regions or subsets of the primitive that are to be rendered as a result of the graphical instructions received in block 405. The routine proceeds to block 420.

At block 420, the SPI checks a state of a pixel wave attribute tracking array (PWATA) to determine whether pixel wave attributes associated with the identified large primitive are already stored in one or more LDS blocks. If the PWATA indicates that the pixel wave attributes associated with the large primitive are already stored in the LDS, the routine 400 skips to block 440, bypassing the initialization steps and conserving processing resources.

If it was determined in block 420 that the PWATA does not indicate that attribute data associated with the large primitive identified in block 410 is already stored within the LDS (as described elsewhere herein, e.g. with respect to FIG. 3), the routine 400 proceeds to block 425 and initiates the reading of attributes from the parameter cache for the identified large primitive. The routine proceeds to block 430.

At block 430, the SPI stores the attributes retrieved in block 425 in the designated LDS blocks corresponding to the compute units (CUs) assigned to process the pixel waves of that large primitive. The routine proceeds to block 435.

At block 435, the SPI updates the state of the PWATA to indicate the LDS blocks in which the attributes for the identified large primitive were stored in block 430. This enables the SPI to identify the storage status of those attributes when processing subsequent pixel waves. The routine proceeds to block 440.

At block 440, the pixel wave being processed is rendered using the attributes stored in local data storage, either after updating the PWATA in block 435 or if it was determined in block 420 that the pixel wave attributes had been previously stored in the LDS during processing of a previous pixel wave. In either case, the SPI utilizes the attributes retrieved from the LDS blocks of the assigned CUs. The routine proceeds to block 445.

At block 445, the SPI determines whether any additional pixel waves associated with the currently identified large primitive remain to be processed. If so, the routine proceeds to block 420 for processing the next pixel wave. Conversely, if all pixel waves of the identified large primitive have been processed, the routine returns to block 410 to identify and process any subsequent large primitives.

In some embodiments, the apparatus and techniques described above are implemented in a system including one or more integrated circuit (IC) devices (also referred to as integrated circuit packages or microchips), such as the systems, operations, and components described above with reference to FIGS. 2-4. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

One or more of the elements described above is circuitry designed and configured to perform the corresponding operations described above. Such circuitry, in at least some embodiments, is any one of, or a combination of, a hardcoded circuit (e.g., a corresponding portion of an application specific integrated circuit (ASIC) or a set of logic gates, storage elements, and other components selected and arranged to execute the ascribed operations), a programmable circuit (e.g., a corresponding portion of a field programmable gate array (FPGA) or programmable logic device (PLD)), or one or more processors executing software instructions that cause the one or more processors to implement the ascribed actions. In some embodiments, the circuitry for a particular element is selected, arranged, and configured by one or more computer-implemented design tools. For example, in some embodiments the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry,” “circuitry modules,” etc.) are described or claimed as “configured” to perform one or more tasks or operations. This formulation—an [entity] configured to [perform one or more tasks] —is used herein to refer to structure (i.e., something physical, such as electronic circuitry). More specifically, this formulation is used to indicate that this physical structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
reading one or more attributes of a first primitive from a parameter cache to initialize a first pixel wave using the one or more attributes; and
omitting reading the one or more attributes from the parameter cache to initialize a second pixel wave in response to determining that the second pixel wave is associated with the first primitive.

2. The method of claim 1, wherein initializing the first pixel wave comprises storing the one or more attributes read from the parameter cache in one or more blocks of a local data store (LDS) that is associated with a compute unit assigned to render the first pixel wave.

3. The method of claim 2, further comprising maintaining a tracking array that indicates the one or more LDS blocks in which the one or more attributes are stored.

4. The method of claim 3, wherein maintaining the tracking array comprises storing the tracking array in the parameter cache.

5. The method of claim 3, wherein maintaining the tracking array includes setting a bit value at a location in the tracking array corresponding to an LDS block in which at least one attribute of the one or more attributes of the first primitive is stored.

6. The method of claim 2, further comprising rendering the first and second pixel waves using the one or more attributes stored in the LDS blocks.

7. The method of claim 1, wherein determining that the second pixel wave is associated with the first primitive comprises comparing parameter cache addresses of one or more vertices associated with the second pixel wave to parameter cache addresses of one or more vertices associated with the first primitive.

8. The method of claim 1, further comprising identifying the first primitive as a large primitive based on a quantity of pixels associated with the first primitive.

9. The method of claim 1, further comprising identifying the first primitive as a large primitive based on a quantity of shader operations required to render the first primitive.

10. The method of claim 1, further comprising identifying the first primitive as a large primitive based on a quantity of memory required to store attributes associated with the first primitive.

11. A processing unit comprising:
a parameter cache; and
scheduling circuitry configured to:
read one or more attributes of a first primitive from the parameter cache to initialize a first pixel wave using the one or more attributes; and
omit reading the one or more attributes from the parameter cache to initialize a second pixel wave in response to a determination that the second pixel wave is associated with the first primitive.

12. The processing unit of claim 11, further comprising a plurality of compute units that are each associated with a local data store (LDS), and wherein to initialize the first pixel wave comprises to store the one or more attributes read from the parameter cache in one or more blocks of an LDS that is associated with one compute unit of the plurality of compute units, the one compute unit being one of one or more compute units assigned to render the first pixel wave.

13. The processing unit of claim 12, further comprising a tracking array to store one or more indications of the one or more LDS blocks in which the one or more attributes are stored.

14. The processing unit of claim 13, wherein the scheduling circuitry is further configured to maintain the tracking array, and wherein to maintain the tracking array includes to store the tracking array in the parameter cache.

15. The processing unit of claim 13, wherein to maintain the tracking array includes to set a bit value at a location in the tracking array that corresponds to an LDS block in which at least one attribute of the one or more attributes of the first primitive is stored.

16. The processing unit of claim 12, further comprising rendering the first and second pixel waves by the one or more assigned compute units using the one or more attributes stored in the one or more LDS blocks.

17. The processing unit of claim 11, wherein the scheduling circuitry is further configured to compare parameter cache addresses of vertices associated with the second pixel wave to parameter cache addresses of vertices associated with the first primitive in order to determine that the second pixel wave is associated with the first primitive.

18. The processing unit of claim 11, wherein the scheduling circuitry is further configured to identify the first primitive as a large primitive based on a quantity of pixels associated with the first primitive.

19. The processing unit of claim 11, wherein the scheduling circuitry is further configured to identify the first primitive as a large primitive based on a quantity of shader operations required to render the first primitive.

20. The processing unit of claim 11, wherein the scheduling circuitry is further configured to identify the first primitive as a large primitive based on a quantity of memory required to store attributes associated with the first primitive.

21. A method, comprising:
receiving a set of instructions associated with a graphical primitive;
storing attributes of the graphical primitive in a parameter cache to initialize a first pixel wave; and
determining, based on the set of instructions, to launch a subsequent pixel wave associated with the graphical primitive without initializing parameters for the subsequent pixel wave.
